(19) United States
(12) Patent Application Publication
(10) Pub. No.: US 2008/0120046 A1
(43) Pub. Date: May 22, 2008

(54) FLUID METERING APPARATUS

(76) Inventors: CHUN-CHIN TUNG, CHUPEI (TW); YUNG-LIEH CHIEN, CHUPEI (TW)

Correspondence Address: G. LINK CO., LTD., 3550 BELL ROAD, MINOOKA, IL, 60447, US

(21) Appl. No.: 11/943,596

(22) Filed: Nov. 21, 2007

(30) Foreign Application Priority Data
Nov. 22, 2006 (TW) 095143180

(51) Int. Cl. G01F 23/26

(52) U.S. Cl. 702/52; 702/53

(57) ABSTRACT

The present invention relates to a fluid metering apparatus, which includes a fluid container and a metering device. The container has a hollow part for storing fluid and the metering device includes electrical metering means and data processing means. The electrical metering means detects change of a physical quantity of the fluid in the container, and the characteristic is expressed with an electrical mode. The data processing means treats the electrical information obtained by the electrical metering means, and converts the electrical information into a physical characteristic of the fluid. The electrical metering means includes a metering component, which provides a strip line component. Moreover, the electrical information is an electrical signal selected from a capacitance value, an inductance value or an impedance value of the strip line component or a combination of the preceding values.

### FIELD OF THE INVENTION

The present invention relates to a fluid metering apparatus, and more particularly to a fluid metering apparatus which is capable of detecting a physical characteristic of a fluid, especially volume of a liquid.

### BACKGROUND OF THE INVENTION

The conventional fluid metering device is employed to measure a physical characteristic of a fluid such as concentration, density or quantity. Usually, the conventional fluid metering device is big in size with complicated parts and it results in higher cost. However, products, which are small in size with low costs, are getting important due to being demanded in the market. Taking the fuel cell system as an example, the fuel cell has a cell core to output power by means of the hydrogen-rich fuel, such as methanol, performing electrochemical reaction with oxygen. In the field of fuel cell application, in order to notify the user when the concentration of the fuel or the fuel storage is insufficient and when the fuel needs to be supplemented, it is required to detect liquid level and quantity of the fuel contained in the fuel container. Currently, both the concentration and the quantity of the fuel in the ordinary fuel container are detected with an expensive metering sensor but it is uneconomical if the costly metering sensor is largely utilized in portable electronic products. Further, there are many intermediate products or the like in the process of the electrochemical reaction and temperature of the fuel may change in accordance with electrochemical reaction. As a result, errors occur inevitably.

For overcoming the above-mentioned drawbacks of the prior art, a fluid metering apparatus according the present is provided.

### SUMMARY OF THE INVENTION

It is an object of the present invention to provide a fluid metering apparatus which can measuring physical characteristics of the fuel such as concentration, density, liquid level and etc.

It is another object of the present invention to provide a fluid metering apparatus with which an electrical signal corresponding to a capacitance value, an inductance value or an impedance of a simple strip line component can be measured or any one of electrical signal of the preceding electrical signal combinations can be measured such that a corresponding physical characteristic of the fuel can be obtained.

It is a further object of the present invention to provide a fluid metering apparatus which can offer a reference electrical signal for correcting error resulted from other products created by the electrochemical reaction or change of temperature.

To obtain the aforementioned objects, the present invention provides a fluid metering apparatus, which comprises a fluid container and a metering device. The fluid container has a hollow part for storing the fuel, and the fluid metering device further comprises electrical metering means and data processing means. The electrical metering means detects electrical information caused by physical change of the fuel in the fluid container. The data processing means converts the detected electrical information into a physical characteristic of the fuel. The electrical metering means includes a measuring component, which further includes a strip line component, and the electrical information is an electrical signal selected from a capacitance value, an inductance value or an impedance value of the strip line component or any one electrical signal of the preceding electrical signal combinations.

The preceding electrical metering means includes several strip line components, which vertically extend along a direction toward a depth of the hollow part. The preceding data processing means includes saving the corresponding relationship between the electrical signal and a physical characteristic of the fluid. Moreover, the physical characteristic of the fluid is one of the liquid level, density of the fluid and concentration of the fluid.

Furthermore, the strip line component is fork-shaped strip line capacitance component, or further is a micro strip line component.

In addition, the electrical metering means further includes a second strip line component sealed with a specimen fluid which is identical with the fluid stored in the hollow part. The specimen fluid maintains at an initial state and temperature of the specimen fluid varies with the temperature of the fluid in the hollow part. Hence, influence resulting from temperature factor or other products created during the electrochemical reaction can be taken away from the reference electrical signal obtained with the second strip line component.

The preceding strip line component can be utilized in a fuel cell system and disposed in a fluid container for storing fuel. The strip line component can detect the physical quantity of the fluid and produce corresponding electrical signal.

### BRIEF DESCRIPTION OF THE DRAWINGS

The foregoing and other features and advantages of the present invention will be more clearly understood to those who are skilled in the art through the following descriptions of the preferred embodiment with reference to the drawings, wherein:

FIG. 1 is a block diagram illustrating the components of a fluid metering apparatus according to a preferred embodiment of the present invention;

FIG. 2 is a perspective view illustrating the preferred embodiment of a fluid metering apparatus according to the present invention;

FIG. 3 is a side view illustrating the preferred embodiment of a fluid metering apparatus according to the present invention;

FIG. 4 is an enlarged diagram illustrating the components configured in a fluid metering device according to the preferred embodiment of the present invention;

FIG. 5 is a cross sectional diagram illustrating the preferred embodiment of a fluid metering apparatus according to the present invention;

FIG. 6 is an enlarged side view illustrating the components configured in a fluid metering apparatus according to another preferred embodiment of the present invention;

FIG. 7 is an enlarged side view illustrating the components configured in a fluid metering apparatus according to a further preferred embodiment of the present invention;

FIG. 8 is an enlarged side view illustrating the components configured in the fluid metering apparatus shown in FIG. 7; and

FIG. 9 is an enlarged side view illustrating the components configured in a fluid metering apparatus according to still a further preferred embodiment of the present invention.

### DETAILED DESCRIPTION OF THE INVENTION

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

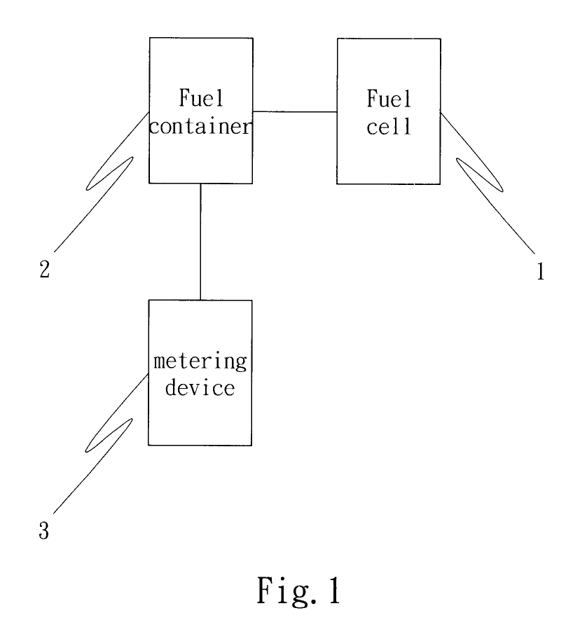

Please refer to FIG. 1, which is a block diagram illustrating the components of a fluid metering apparatus according to a preferred embodiment of the present invention in association with a fuel cell system. The fluid metering apparatus in the preferred embodiment is implemented as a metering device 3 mounted to a fuel container 2 of a fuel cell 1 and the metering device 3 is configured in the fuel container 2 to detect the physical property of the fuel stored in the fuel container 2. The fuel cell 1 possesses a catalyst to perform electrochemical reaction with the hydrogen-rich fuel and oxygen fuel and acts as an energy converter to convert chemical energy to electrical energy output. The fuel container 2 stores the fuel required by the fuel cell 1 for carrying out the electrochemical reaction, and provides delivering means for supplying the fuel to the fuel cell 1. Moreover, the metering device 3 is employed to measure physical characteristics of the fuel and provides electrical metering means and data processing means. The electrical metering means is used for detecting the electrical characteristics resulting from physical change of the fluid fuel in the container 2. The data processing means is used for converting information relating to the electrical characteristics, which have been detected by the electrical type metering means, into the physical characteristics of the fuel.

The data processing means includes an operation chip, a memory chip and a connecting circuit.

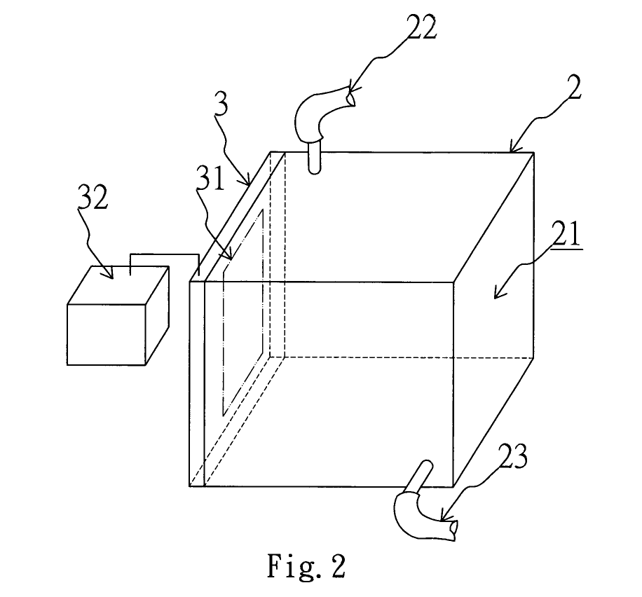

Please refer to FIG. 2, which is a perspective view illustrating the preferred embodiment of a fluid metering apparatus according to the present invention. The metering device 3 is configured in the fuel container 2 and the fuel container 2 is a case with a hollow part 21 and the hollow part 21 is connected to a fuel inlet 22 and a fuel outlet 23 for respectively inputting and outputting the fluid fuel. The metering device 3 is placed in the fuel container 2. The electrical type metering means includes a capacitance type measuring component 31 and the data processing means has a processor 32 so that the physical characteristics of the fuel in the container 2 can be detected with the electrical type metering means and then processed with the data processing means. For example, the physical characteristics of the fuel may be the liquid level, the density, the concentration and other properties. A capacitance value of the capacitance type measuring component 31 is calculated with the data processing means so that a physical quantity for one of the physical characteristics corresponding to the capacitance value can be obtained. Furthermore, the quantity relation or function relation between the capacitance value and the physical quantity is stored in the processor 32 so that the physical quantity corresponding to the capacitance value can be obtained through relationship between the capacitance value and the physical quantity and operation of the processor 32. Meanwhile, the processor 32 is capable of performing the ordinary data transmission and achieving effectiveness of the conventional data processor.

The capacitance type measuring component 3 i can be replaced with a micro strip line such that message relating to the physical characteristics of the fuel can be received by way of measuring electrical signal of the strip line. Further, the measured electrical signal of the strip line can be equivalent capacitance value, equivalent inductance value, impedance value or combination of the preceding electrical signals of the strip line component.

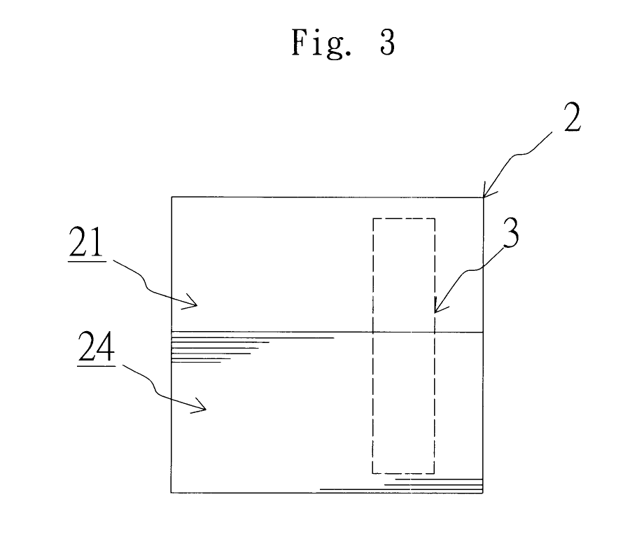

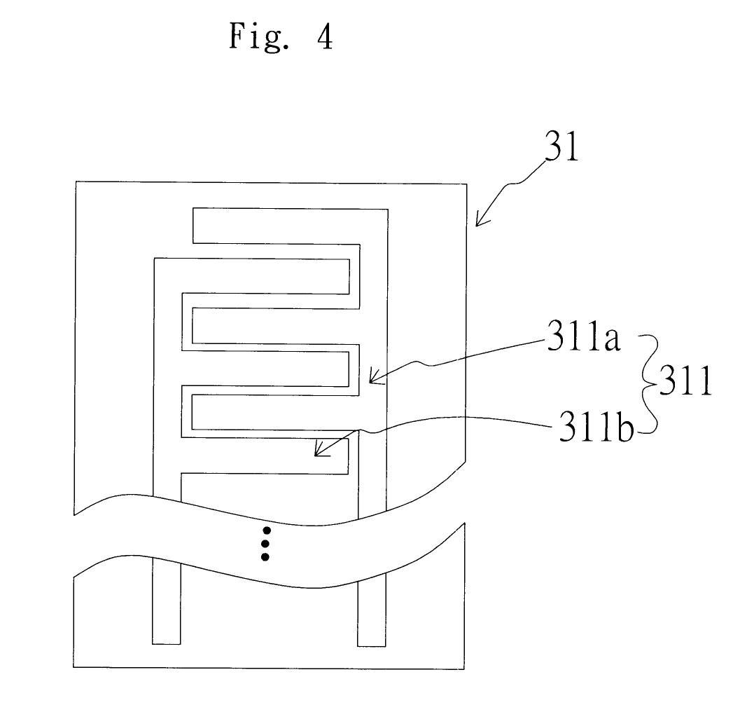

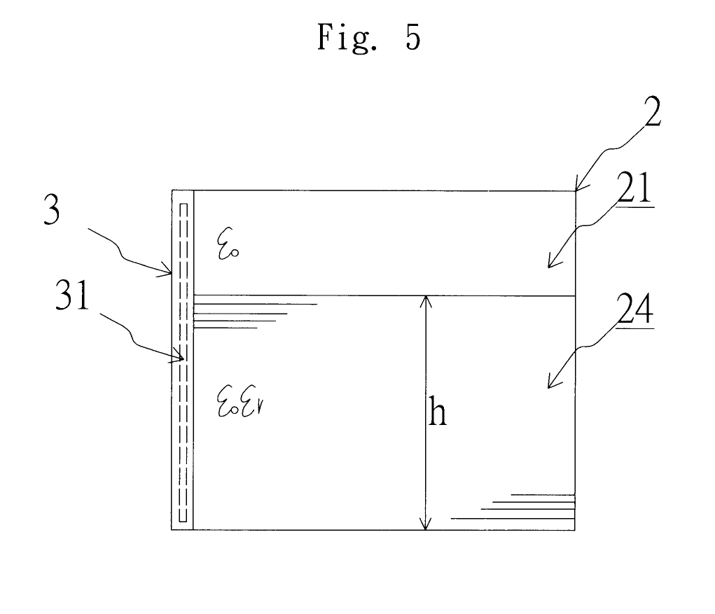

Please refer to FIGS. 3, 4 and 5, which are respectively a side view illustrating the preferred embodiment of a fluid metering apparatus according to the present invention, an enlarged diagram illustrating the components configured therein, and a cross sectional diagram illustrating the preferred embodiment thereof. As shown in FIG. 3, the capacitance measuring component 31 of the electrical metering means of the metering device 3 is vertically extended along the direction of depth of the hollow part 21 of the fuel container 2. As shown in FIG. 4, the capacitance type measuring component 31 can be a fork-shaped capacitance component 311 which includes a first capacitance portion 311a and a second capacitance portion 311b. The first capacitance portion 311a and the second capacitance portion 311b respectively have a plurality of parallel fork-shaped strip lines extending laterally and alternately in the horizontal direction to induce an electrical capacitance effect between the first capacitance portion 311a and the second capacitance portion 311b. As shown in FIG. 5, the capacitance effect between the first capacitance portion 311a and the second capacitance portion 311b is influenced by the dielectric in the hollow part 21 of the container 2. For example, when the liquid level of the fuel 24 in the hollow part 21 of the container 2 lowers to a height h, it results in change of the capacitance value of the fork-shaped capacitance component 311 due to proportion of the air dielectric ε0 to the fuel dielectric ε0εr changing. Accordingly, the capacitance value corresponding to the fork-shaped capacitance component 311 changes too. Hence, it is achievable to obtain the corresponding relationship of the capacitance value and the height h through recordation of experimentation, theory or experiential formula and such corresponding relationship could be stored in the processor 32. Thus, the capacitance value of the fork-shaped capacitance component 311 can be converted into the information regarding the liquid level of the fuel 24 when the capacitance value is fed back to the data processing means.

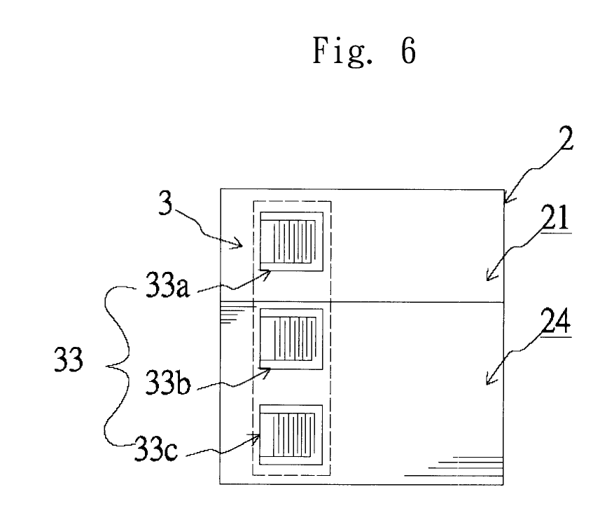

Please refer to FIG. 6, which is an enlarged side view illustrating the components configured in a fluid metering device according to another preferred embodiment of the present invention. In the preceding metering device 3, the electrical metering means, which extends along depth of the hollow part 21 vertically, has several capacitance measuring components 33. Specifically, the capacitance measuring components 33 are fork-shaped capacitance components and include a first capacitance measuring component 33a, a second capacitance measuring component 33b and a third capacitance measuring component 33c. The capacitance measuring components 33 are capable of providing the capacitance effect respectively. Similarly, it can be seen in FIG. 5 that the capacitance effect of the respective capacitance measuring component 33 is influenced with the dielectric in the hollow part 21 of the container 2. For example, when the liquid level of the fuel 24 in the hollow part 21 of the container 2 is lowered to a height h, the capacitance values corresponding to the first, the second and the third capacitance components 33a, 33b and 33c are changed due to proportion of the air dielectric ε0 and the fuel dielectric ε0εr changing. Accordingly, the capacitance value of the respective capacitance measuring component 33 can be converted into the information regarding the liquid level of the fuel 24 when the capacitance value of the respective capacitance measuring component 33 is fed back to the data processing means.

As the preceding embodiment shown in FIG. 3, the length of the capacitance measuring component 31 extends along with the height of the hollow part 21 in the container 2 so that the capacitance measuring component 31 is able to obtain the electrical information corresponding to the liquid level of the fuel. The measured range of height designed for the capacitance measuring component 31 is that the user or the designer is interested in instead of the height of the hollow part 21. Furthermore, in the embodiment as shown in FIG. 6, the capacitance measuring components 33 are arranged to correspond to different elevations in the hollow parts 21 of the container 2. Accordingly, the capacitance measuring component 31 illustrated in FIG. 3 is capable of measuring the liquid level of the fuel in a large range of height, while the capacitance measuring components 33 as shown in FIG. 6 are capable of measuring the liquid level of the fuel for local ranges of the liquid fuel level. Alternatively, the liquid level of the fluid fuel can be divided into several intervals with switches and the capacitance measuring components 33 correspond to the intervals respectively such that it can be determined if the corresponding interval has the fuel for the liquid level of the fuel being determined as well.

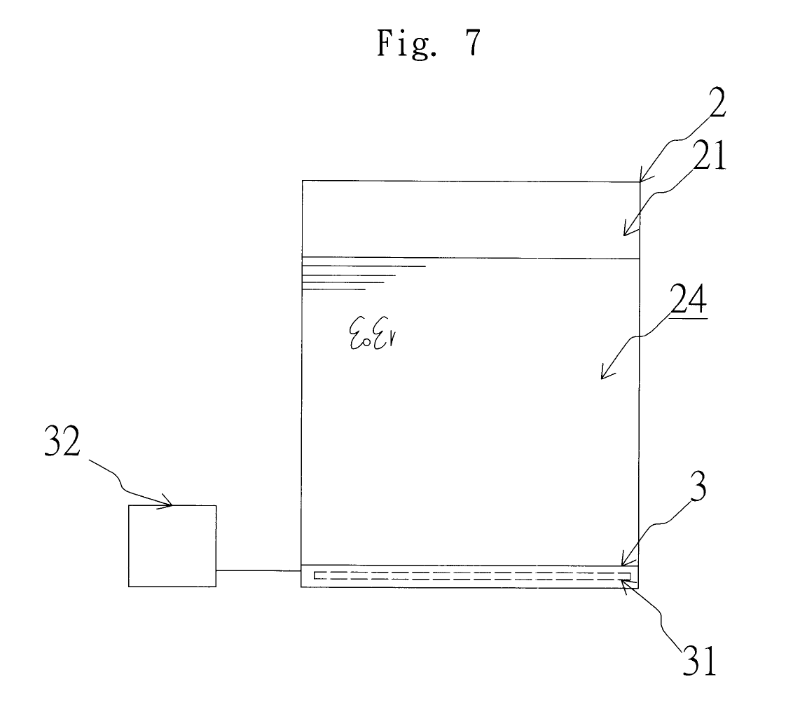

Please refer to FIG. 7, which is an enlarged side view illustrating the components configured in a fluid metering apparatus according to a further preferred embodiment of the present invention. In this embodiment, the capacitance measuring component 31 of the electrical metering means in the preceding metering device 3 extends along the hollow part 21 of the container 2 horizontally and is configured at the bottom of the hollow part 21 so that the capacitance effect of the capacitance measuring component 31 is influenced with the dielectric in the hollow part 21. For example, when the physical characteristic with regard to the fuel concentration in the hollow part 21 of the container 2 is changed, the dielectric εr of the fuel would be changed correspondingly. As a result, the capacitance value corresponding to the capacitance measuring component 31 changes as well. Accordingly, the relationship between the capacitance value and the fuel concentration can be obtained by way of experimentation, theory or experiential formula. Further, such relationship can be stored in the processor 32 such that the capacitance value of the capacitance measuring component 31 is capable of being converted into the information of the concentration of the fuel 24 when the capacitance value of the capacitance measuring component 31 is fed back to the data processing means.

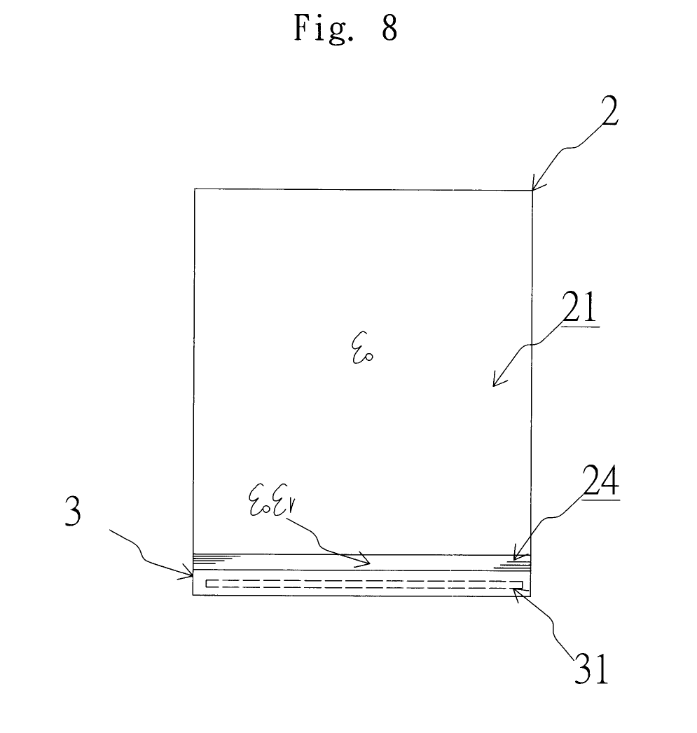

Please refer to FIG. 8, which is an enlarged side view illustrating the components configured in a fluid metering apparatus shown in FIG. 7. When the liquid level becomes lower due to the fuel 24 in the hollow part 21 of the container 2 keeping decreasing and it makes the air dielectric ε0 dominative, it can be learned from the electrical information obtained by the capacitance measuring component 31 of the metering device 3 that the liquid level of the fuel 24 is excessively low. In other words, it is determined from the data processing means that the fuel is almost exhausted.

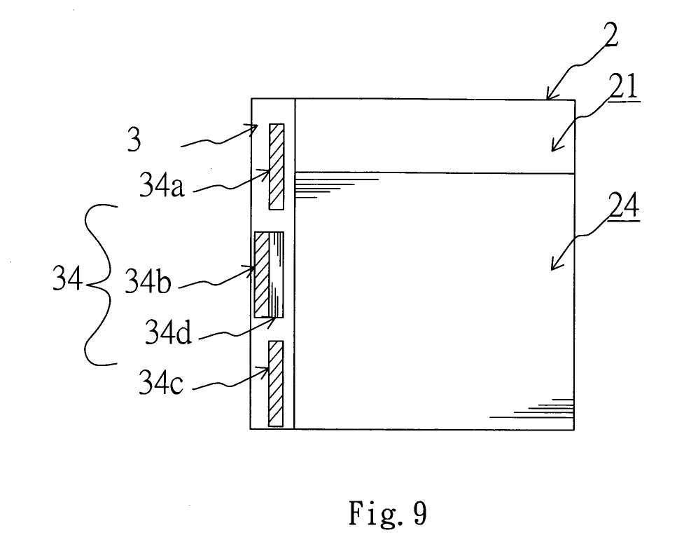

Please refer to FIG. 9, which is an enlarged side view illustrating the components configured in a fluid metering apparatus according to still a further preferred embodiment of the present invention. In this embodiment, the electrical metering means of the metering device 3 includes several capacitance measuring components 34 and the capacitance measuring components 34 further includes a first capacitance measuring component 34a, a second capacitance measuring component 34b and a third capacitance measuring component 34c. The capacitance measuring components 34 provide a capacitance effect respectively. As shown in FIG. 9, the second capacitance component 34b has the specimen fuel 34d sealed therein and the specimen fuel 34d is identical with those of the fuel 24 stored in the hollow part 21 of the container 2. Accordingly, even though the physical characteristics of the fuel 24 in the chamber 21 of the container 2 are changed, the specimen fuel 34d sealed in the second capacitance measuring component 34b still maintains at the initial state. Hence, the capacitance value measured with the second capacitance measuring component 34b is capable of being regarded as a reference capacitance value for the data processing means determining the changes of the physical characteristics of the fuel 24 in the hollow pars 21 of the container 2.

Moreover, although change of the temperature of the fuel 24 in hollow part 21 of the container 2 may influence the specimen fuel 34d sealed in the second capacitance measuring component 34b, the side effect influenced with temperature factor can be taken away from the obtained reference capacitance value properly.

While the preferred embodiment of the invention has been disclosed above, it is not intended to restrict the scope of the invention. Therefore, any modification or variation under the spirit of the invention would still be in the scope of the present invention.

What is claimed is:

1. A fluid metering apparatus comprising:
a metering device further comprising an electrical type metering means for detecting an electrical characteristic of a fluid due to physical change and a data processing means for processing information relating to said electrical characteristic and converting said information into a physical characteristic of said fluid;
wherein said electrical metering means further comprises a measuring component and said measuring component includes a strip line component, and said information is an electrical signal selected from a capacitance value, an inductance value or an impedance value of said strip line or a combination of said values.

2. The fluid metering apparatus according to claim 1 further comprises a fluid container, which provides a hollow part for storing said fluid, and said strip line component is provided at the fluid container.

3. The fuel metering apparatus according to claim 2, wherein said strip line component vertically extends along a direction toward a depth of said hollow part.

4. The fluid metering apparatus according to claim 3, wherein said strip line component extends a length in accordance with a height of said hollow part for said measuring component being capable of obtaining said information corresponding to a liquid level of said fluid.

5. The fluid metering apparatus according to claim 4, wherein said measuring component includes a fork-shaped strip line capacitance component.

6. The fluid metering apparatus according to claim 5, wherein said strip line capacitance component is a micro strip line component.

7. The fluid metering apparatus according to claim 2, wherein said strip line component horizontally extends along the bottom of said hollow part.

8. The fluid metering apparatus according to claim 2, wherein said electrical metering means includes a plurality of strip line components.

9. The fluid metering apparatus according to claim 8, wherein said strip line components are distributively arranged and extend vertically along a direction toward a depth of said hollow part.

10. The fluid metering apparatus according to claim 9, wherein said data processing means further includes saving a corresponding relationship between said electrical signal and said physical characteristic and said physical characteristic is one of liquid level, fluid density and fluid concentration of said fluid.

11. The fluid metering apparatus according to claim 10, wherein said strip line component includes a fork-shaped strip line capacitance component.

12. The fluid metering apparatus according to claim 11, wherein said strip line component is a micro strip line component.

13. The fluid metering apparatus according to claim 9, wherein said strip line components correspond to a plurality of liquid level intervals arranged in said hollow parts.

14. The fluid metering apparatus according to claim 2, wherein said electrical metering means further includes a second strip line component sealed with a specimen fluid and said specimen fluid is identical with said fluid.

15. The fluid metering apparatus according to claim 14, wherein said second strip line component obtains a reference electrical signal and said data processing means compares said reference electrical signal with said electrical signal to determine change of said physical characteristic.

16. The fluid metering apparatus according to claim 15, wherein said specimen fluid keeps in an initial state.

17. The fluid metering apparatus according to claim 15, wherein temperature of said specimen fluid changes in accordance with temperature of said fluid in said hollow part such that said reference electrical signal is capable of taking away influence resulting from temperature factor.

18. The fluid metering apparatus according to claim 1, wherein said electrical metering means includes a capacitance measuring component, which is a strip line capacitance component.

19. The fluid metering apparatus according to claim 18, wherein said data processing means further includes saving a corresponding relationship between a capacitance value of said capacitance measuring component and said physical characteristic and said physical characteristic is one of liquid level, fluid density and fluid concentration of said fluid.

20. The fluid metering apparatus according to claim 19, wherein said strip line component includes a fork-shaped strip line component.

21. The fluid metering apparatus according to claim 20, wherein said strip line component is a micro line strip component.

22. The fluid metering apparatus according to claim 1, wherein said data processing means further includes saving a corresponding relationship between said electrical signals and said physical characteristic and said physical characteristic is one of liquid level, fluid density and fluid concentration of said fluid.

23. The fluid metering apparatus according to claim 22, wherein said corresponding relationship is data corresponding relationship obtained via experimental record.

24. The fluid metering apparatus according to claim 1, wherein said data processing means includes an operation chip, a memory chip and electrical wirings such that a reasonable circuit is constituted.

25. The fluid metering apparatus according to claim 24 further comprises a data transmission means in addition to said data processing means.

26. The fluid metering apparatus according to claim 1, wherein said strip line component is provided in a fluid container for receiving fluid fuel in a fuel cell system for detecting a physical quantity of said fluid fuel and producing a corresponding electrical signal.

27. The fluid metering apparatus according to claim 26, wherein said strip line component vertically extends along a direction toward a depth of said hollow part.

28. The fluid metering apparatus according to claim 27, wherein said strip line component extends a length in accordance with a height of said hollow part for said measuring component being capable of obtaining said information corresponding to a liquid level of said fluid.

29. The fluid metering apparatus according to claim 27, wherein said measuring component includes a fork-shaped strip line capacitance component.

30. The fluid metering apparatus according to claim 29, wherein said strip line capacitance component is a micro strip line component.

31. The fluid metering apparatus according to claim 26, wherein said strip line component horizontally extends along the bottom of said hollow part.

32. The fluid metering apparatus according to claim 26, wherein said electrical metering means includes a plurality of strip line components.

33. The fluid metering apparatus according to claim 32, wherein said strip line components are distributively arranged and extend vertically along a direction toward a depth of said hollow part.

34. The fluid metering apparatus according to claim 33, wherein said data processing means further includes saving a corresponding relationship between said electrical signal and said physical characteristic and said physical characteristic is one of liquid level, fluid density and fluid concentration of said fluid.

35. The fluid metering apparatus according to claim 34, wherein said strip line component includes a fork-shaped strip line capacitance component.

36. The fluid metering apparatus according to claim 35, wherein said strip line component is a micro strip line component.

37. The fluid metering apparatus according to claim 33, wherein said strip line components correspond to a plurality of liquid level intervals arranged in said hollow parts.

38. The fluid metering apparatus according to claim 37, wherein said electrical metering means further includes a second strip line component sealed with a specimen fluid and said specimen fluid is identical with said fluid.

39. The fluid metering apparatus according to claim 38, wherein said second strip line component obtains a reference electrical signal and said data processing means compares said reference electrical signal with said electrical signal to determine change of said physical characteristic.

40. The fluid metering apparatus according to claim 39, wherein said specimen fluid keeps in an initial state.

41. The fluid metering apparatus according to claim 39, wherein temperature of said specimen fluid changes in accordance with temperature of said fluid in said hollow part such that said reference electrical signal is capable of taking away influence resulting from temperature factor.

42. The fluid metering apparatus according to claim 26, wherein said electrical metering means includes a capacitance measuring component, which is a strip line capacitance measuring component for feeding back said capacitance value and obtaining said physical characteristic corresponding to said capacitance measuring component.

43. The fluid metering apparatus according to claim 42, wherein said data processing means further includes saving a corresponding relationship between a capacitance value of said capacitance measuring component and said physical characteristic and said physical characteristic is one of liquid level, fluid density and fluid concentration of said fluid.

44. The fluid metering apparatus according to claim 43, wherein said strip line component includes a fork-shaped strip line component.

45. The fluid metering apparatus according to claim 44, wherein said strip line component is a micro line strip component.

46. The fluid metering apparatus according to claim 26, wherein said data processing means further includes saving a corresponding relationship between said electrical signal and said physical characteristic and said physical characteristic is one of liquid level, fluid density and fluid concentration of said fluid.

47. The fluid metering apparatus according to claim 46, wherein said corresponding relationship is data corresponding relationship obtained via experimental record.

48. The fluid metering apparatus according to claim 26, wherein said data processing means includes an operation chip, a memory chip and electrical wirings such that a reasonable circuit is constituted.

49. The fluid metering apparatus according to claim 48 further comprises a data transmission means in addition to said data processing means.
